(19) United States
(12) Patent Application Publication
(10) Pub. No.: US 2011/0240338 A1
(43) Pub. Date: Oct. 6, 2011

(54) Ternary Oxide Supercapacitor Electrodes

(75) Inventors: George Gruner, Los Angeles, CA (US); Ian O'Connor, Santa Monica, CA (US)

(73) Assignee: AMPERICS INC., Los Angeles, CA (US)

(21) Appl. No.: 13/079,773

(22) Filed: Apr. 4, 2011

Related U.S. Application Data
(60) Provisional application No. 61/320,703, filed on Apr. 3, 2010.

(51) Int. Cl. H01B 5/00; B82Y 30/00

(52) U.S. Cl. 174/126.1; 977/773; 977/932; 977/742

(57) ABSTRACT

The present invention describes supercapacitors with enhanced energy density and power density, achieved largely through use of electrodes that incorporate ternary oxide(s). Ternary oxide(s) are ternary nanostructures have the formula AₓB_{y}O_{z}, wherein x ranges from 0.25 to 24, and y ranges from 0.5 to 40, and z ranges from 2 to 100, and wherein A and B are independently selected from groups of elements specified in this application.

### CROSS-REFERENCE TO RELATED APPLICATIONS

This application claims priority from U.S. provisional application No. 61/320,703, filed on Apr. 3, 2010, and incorporated herein by reference in its entirety.

### FIELD OF THE INVENTION

The present invention relates generally to charge storage devices with at least one electrode containing ternary oxide material(s).

### BACKGROUND OF THE INVENTION

Electrochemical capacitors (also known as supercapacitors or ultracapacitors) have been attracting a large amount of interest because of their ability to rapidly provide both higher power density compared to batteries, whilst also providing higher energy density compared to the conventional dielectric capacitors. Such outstanding properties make them excellent candidates for applications in hybrid electric vehicles, computers, mobile electric devices and other technologies.

Generally, an electrochemical capacitor may be operated based on the electrochemical double-layer capacitance (EDLC) formed along an electrode/electrolyte interface, or a pseudocapacitance resulted from a fast reversible faradic process of redox-active materials (e.g., metal oxides and conductive polymers). For an EDLC-based capacitor, the rapid charge/discharge process provides the capacitor with a high power density, yet the energy density is limited by its effective double-layer area.

Compared with the EDLC-based capacitors, pseudocapacitors based on transition metal oxides or conducting polymers may provide much higher specific capacitances up to one thousand farads per gram of the active material. However, their actual applications are still limited by high cost, low operation voltage, or poor rate capability, mostly because of inefficient mass transport or of slow faradic redox kinetics. Specifically, such high electrical resistance can limit the practical thickness (smallest dimension) of oxide electrodes, as increased thickness leads to increased electrode resistance and reduced charge transport.

Layered oxides, such as V₂O₅ have been experimented with in order to fabricate electrodes for batteries and supercapacitors. However, our tests have revealed that these materials suffer from weak interaction between the neighboring layers in supercapacitor electrode applications. For example, in our experiments, ion insertion and extraction between weakly bonded layers resulted in the V₂O₅ rapidly becoming more amorphous and disordered, which directly reduced the Li insertion and extraction efficiency. Our experiments further revealed that these materials are at a disadvantage in supercapacitor electrode applications by having a high electrical resistance. A consequence of this resistance is that only relatively thin electrodes can be fabricated. Additionally, V₂O₅, like many layered metal oxides, is soluble in both aqueous and organic media, reducing the total mass of active electrode material and lowering shelf life.

Consequently, in spite of extensive research and effort, making supercapacitors with high energy and power density still remains challenging. Supercapacitors electrodes of the prior art have not provided the device performance (e.g., energy density, power density, cycling stability, operating voltage) and manufacturability required for many high-performance, commercial applications.

### SUMMARY OF THE INVENTION

The present invention describes supercapacitors with enhanced energy density and power density, achieved largely through use of electrodes that incorporate ternary oxide(s). As used herein, ternary oxide(s) are ternary nanostructures have the formula AₓB_{y}O_{z}, wherein x ranges from 0.25 to 24, and y ranges from 0.5 to 40, and z ranges from 2 to 100, and wherein A and B are independently selected from the group comprising Ag, Al, As, Au, B, Ba, Br, Ca, Cd, Ce, Cl, Cm, Co, Cr, Cs, Cu, Dy, Er, Eu, F, Fe, Ga, Gd, Ge, Hf, Ho, I, In, Ir, K, La, Li, Lu, Mg, Mn, Mo, Na, Nb, Nd, Ni, Os, P, Pb, Pd, Pr, Pt, Rb, Re, Rh, Ru, S, Sb, Sc, Se, Si, Sm, Sn, Sr, Ta, Tb, Tc, Te, Ti, Tl, Tm, U, V, W, Y, Yb, and Zn.

In certain embodiments of the present invention, supercapacitor electrodes comprise molybdenum and/or vanadium-based ternary oxide(s). Our experiments have indicated that these materials are particularly suitable for supercapacitor electrode applications. Exemplary ternary oxides according to these embodiments include, but are not limited to, K_{0.3}MoO₃, Rb_{0.3}MoO₃, Na_{0.33}V₂O₅, Ag_{0.33}V₂O₅, Li_{0.3}V₂O₅, Li_{0.3}Mo₆O₁₂ and LiV₃O₈.

In certain embodiments of the present invention, supercapacitor electrodes comprising ternary oxide(s) can further incorporate electrically conducting carbon materials (e.g., carbon black, carbon nanotubes, graphite and/or graphene).

In certain embodiments of the present invention, supercapacitor electrodes comprising ternary oxide(s) can be used in an asymmetric supercapacitor configuration, for example with a ternary oxide electrode and a carbon electrode.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed; the present invention may be employed in not only supercapacitor applications, but in other applications as well (e.g., batteries, battery-type supercapacitors, etc.). As used herein, “substantially” shall mean that at least 40% of components are of a given type.

### BRIEF DESCRIPTION OF THE DRAWINGS

The invention is better understood from reading the following detailed description of the preferred embodiments, with reference to the accompanying figures in which:

FIG. 1 is a schematic representation of a supercapacitor electrode according to certain embodiments of the present invention, comprising ternary oxide(s) and electrically conducting carbon material(s);

FIG. 2 is a schematic representation of an asymmetric supercapacitor configuration according to certain embodiments of the present invention, wherein one electrode comprises ternary oxide(s) and another electrode comprises electrically conducting carbon material(s);

FIG. 3 is a graph of the CV behavior of supercapacitor electrodes according to certain embodiments of the present invention;

FIG. 4 is a graph of the CV behavior of asymmetric supercapacitors according to certain embodiments of the present invention;

FIG. 5 is a graph showing the galvanostatic discharge curves for supercapacitor electrodes according to certain embodiments of the present invention; and

FIGS. 6, 7 and 8 are graphs showing the dependence of energy and power on scan rate, according to certain embodiments of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE EMBODIMENTS

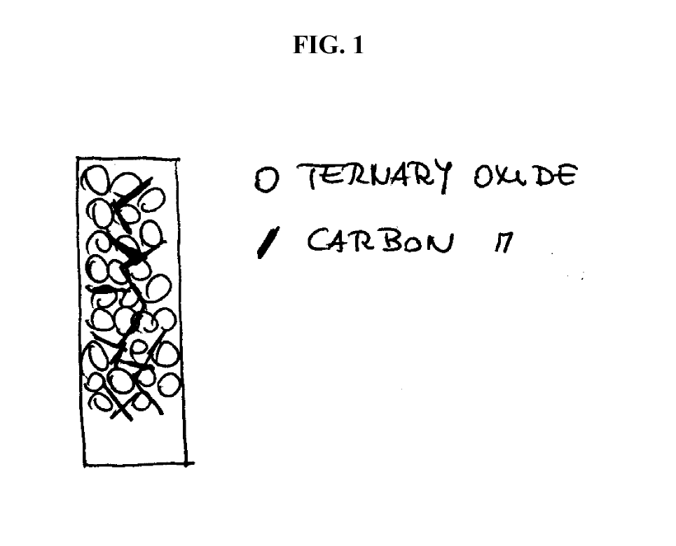

Referring to FIG. 1, supercapacitor electrodes according to certain embodiments of the present invention comprise ternary oxide(s) and electrically conducting carbon material(s). Electrically conducting carbon material(s) include, but are not limited to, carbon black, carbon nanotubes, graphite and/or graphene. Ternary oxide materials according to certain embodiments of the present invention can be prepared using a variety of methods. For example:

Vanadium-Based Compounds:

Synthesis of LiV₃O₈

Nano-scale forms of this material can be fabricated using a sol-gel method. LiV₃O₈ nanowires may also be made using the sol-gel method, and such geometry may lead to enhanced capacitance.

Synthesis of Na_{0.33}V₂O₅

Na_{0.33}VO₃ was prepared by a solid state reaction using a 1:1 molar ratio of Na₂CO₃ and V₂O₅ in air. V₂O₃ was synthesized by a reduction of V₂O₅ in H₂. Both compounds were then mixed with V₂O₅ and heated to 600° C. in an evacuated silica tube to initiate a further solid state reaction resulting in the preparation of Na_{0.33}V₂O₅ product.

Molybdenum-Based Compounds:

NaMoO₃ and LiMoO₃:

MoO₃ powder was heated to 600° C. overnight in air to increase the particle size and so facilitate the subsequent filtration and washing of the products. Five grams of this powder was suspended in 250 cm³ distilled water and N₂ gas bubbled through the suspension for half an hour. After this, a dry mixture of 2 g Na₂S₂O₄ and 60 g Na₂MoO₄.2H₂O (for NaMoO₃ product), or 2 g Li₂S₂O₄+60 g Li₂MoO₄.2H₂O (for LiMoO₃ product), was simultaneously added to the suspension and the reaction mixture stirred for 3 hours. The reaction was carried out at room temperature and N₂ was bubbled through the reaction mixture throughout the reaction time. The dark purplish-blue metallic-luster product was collected by suction-filtration and the product water-washed until the filtrate was colorless. The product was then vacuum dried by heating overnight at 50° C. in a vacuum oven (pressure>30 in Hg vac).

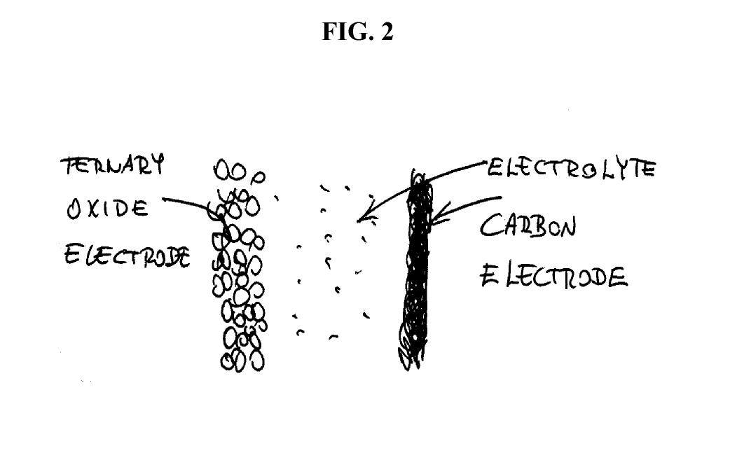

Referring to FIG. 2, certain embodiments of the present invention comprise an asymmetric supercapacitor, wherein an electrode comprises ternary oxide(s). In certain experimental embodiments, a LiV₃O₈ electrode was fabricated and tested. The electrode was fabricated by combining LiV₃O₈ powder with 5% binder and 5% carbon nanotubes into a slurry, which was then deposited onto a stainless steel electrode.

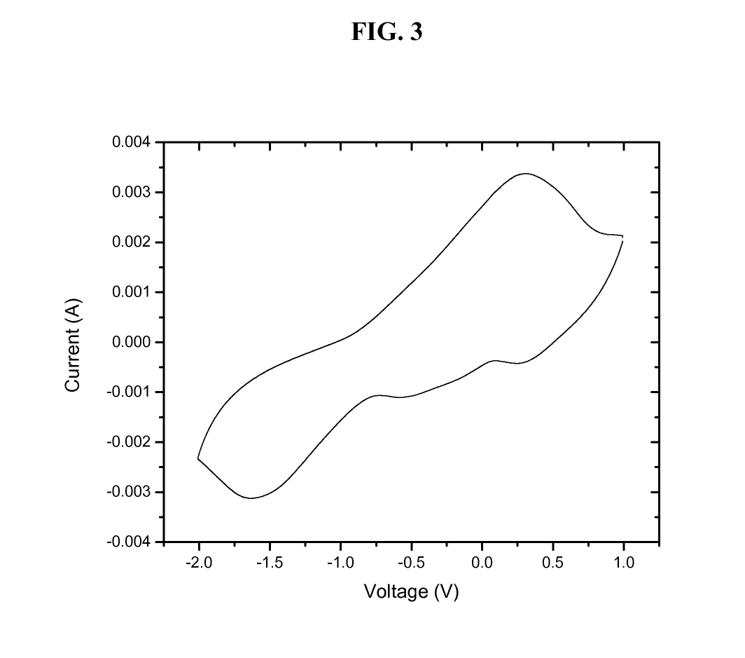

Referring to FIG. 3, CV tests of the aforementioned LiV₃O₈ electrode were performed in organic electrolyte propylene carbonate (PC) with LiClO₄ between −2.0 to +1.0 V at 5 mV/s with an Ag/Ag+ electrode. The capacitance corresponding to an exemplary curve was 89 F/g, which is comparable to results achieved with activated carbon.

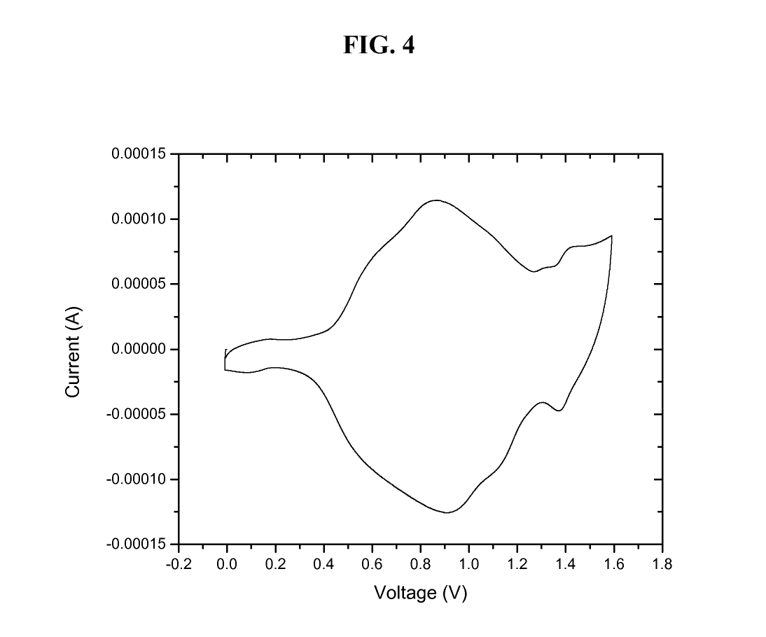

Referring to FIG. 4, asymmetric supercapacitors fabricated with LiV₃O₈-Activated carbon (AC) electrodes (90 F/g) in a 1:1 mass ratio and were analyzed through both cyclic voltammetry (CV) and galvanostatic discharge (GC).

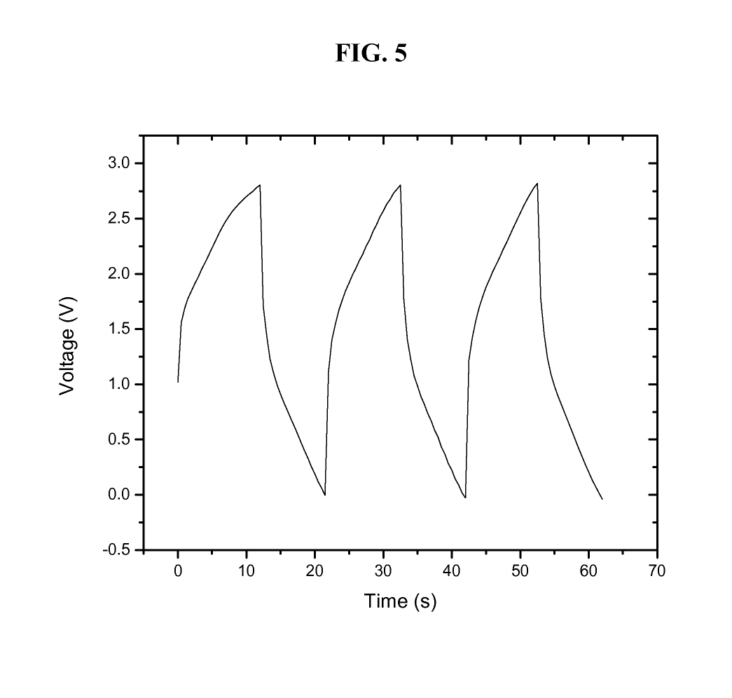

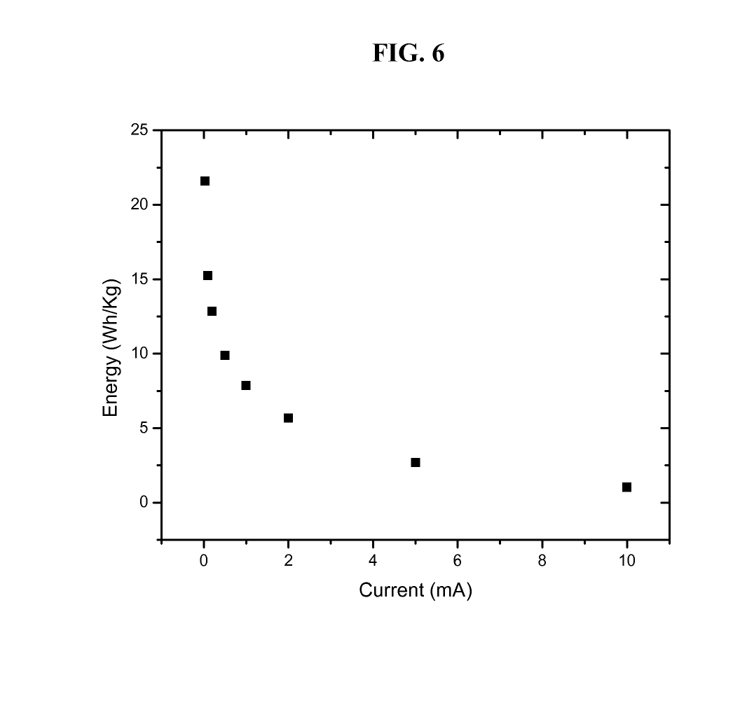

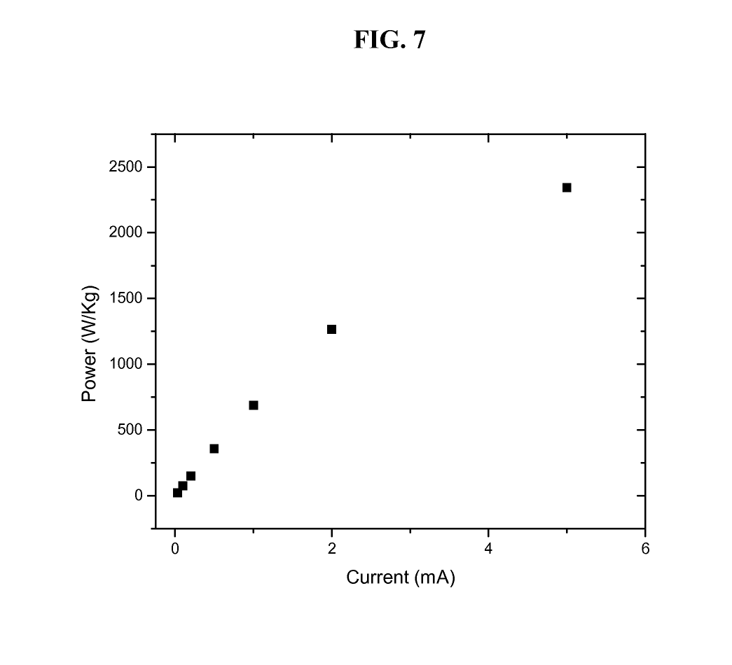

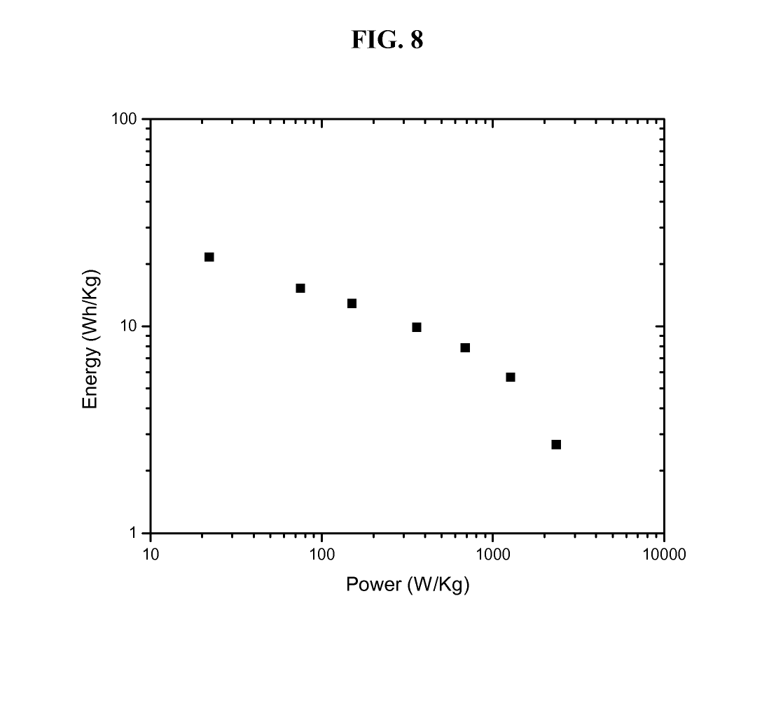

Referring to FIG. 5, from the original 3-electrode measurement, we were able to estimate the energy density under optimum conditions (asymmetric configuration with activated carbon) as 33 Wh/kg. Experimentally the true energy and power density were found by analyzing the galvanostatic discharge curves. The voltage was measured according to a predefined fixed current. The typical charge/discharge curve in FIG. 3 was measured at 5 mA and its energy density was found to be 2.68 Wh/kg. To gain a true understanding, we varied the current, as the energy may change. Our measurements were performed at 10, 5, 2, 1, 0.5, 0.2, 0.1 and 0.03 mA (see Table 1). We were also able to measure the power, which at this current we calculated to be 2343 W/kg.

The present invention has been described above with reference to preferred features and embodiments. Those skilled in the art will recognize, however, that changes and modifications may be made in these preferred embodiments without departing from the scope of the present invention. For example, composite electrodes according to certain embodiments of the present invention may comprise interpenetrating networks of CNTs and other nanowires (e.g., those formed from metal oxides such as MnO₂, CO₃O₄ and/or NiO). All references cited anywhere in this specification are hereby incorporated herein by reference.

TABLE 1

| Current (mA) | Power (W/Kg) | Energy (Wh/Kg) |
|---|---|---|
| 10 | 2088 | 1.03 |
| 5 | 2343 | 2.68 |
| 2 | 1265 | 5.67 |
| 1 | 690 | 7.86 |
| 0.5 | 358 | 9.87 |
| 0.2 | 150 | 12.84 |
| 0.1 | 75 | 15.23 |
| 0.03 | 22 | 21.6 |

What is claimed is:

1. An electrode comprising: a ternary oxide.

2. The electrode of claim 1, wherein the ternary oxide has the formula AₓB_{y}O_{z},
wherein x ranges from 0.25 to 24,
wherein y ranges from 0.5 to 40,
wherein z ranges from 2 to 100, and
wherein A and B are independently selected from the group comprising Ag, Al, As, Au, B, Ba, Br, Ca, Cd, Ce, Cl, Cm, Co, Cr, Cs, Cu, Dy, Er, Eu, F, Fe, Ga, Gd, Ge, Hf, Ho, I, In, Ir, K, La, Li, Lu, Mg, Mn, Mo, Na, Nb, Nd, Ni, Os, P, Pb, Pd, Pr, Pt, Rb, Re, Rh, Ru, S, Sb, Sc, Se, Si, Sm, Sn, Sr, Ta, Tb, Tc, Te, Ti, Tl, Tm, U, V, W, Y, Yb, and Zn.

3. The electrode of claim 2, wherein the oxide is a molybdenum-based compound.

4. The electrode of claim 2, wherein the oxide is a vanadium-based compound.

5. The electrode of claim 1, wherein the ternary oxide takes a form of a nanowire.

6. The electrode of claim 1, wherein the ternary oxide takes the form of a nanoparticle, wherein at least one dimension of the nanoparticle has a size less than 100 nanometers.

7. The electrode of claim 1, further comprising an electrically conducting carbonaceous material.

8. The electrode of claim 7, where the electrically conducting carbonaceous material is a carbon nanotube.

9. The electrode of claim 1, wherein the electrode is incorporated into an asymmetric supercapacitor,
wherein a second electrode comprises an electrically conducting carbonaceous material.
